(19) United States
(12) Patent Application Publication
(10) Pub. No.: US 2002/0034009 A1
(43) Pub. Date: Mar. 21, 2002

(54) Luminance-contrast performance of a display by an in-tube reflective polarizer

(75) Inventors: Dirk Jan Broer, Eindhoven (NL); Hendrik De Koning, Eindhoven (NL); Gosse Charles De Vries, Eindhoven (NL)

Correspondence Address: Corporate Patent Counsel, U.S. Phillips Corporation, 580 White Plains Road, Tarrytown, NY, 10591, US

(73) Assignee: KONINKLIJKE PHILIPS ELECTRONICS N.V.

(21) Appl. No.: 09/954,644

(22) Filed: Sep. 18, 2001

(30) Foreign Application Priority Data
Sep. 21, 2000 (EP) 00203309.0

(51) Int. Cl. G02B 5/30; G02B 27/28

(52) U.S. Cl. 359/497; 359/494; 359/498

(57) ABSTRACT

An assembly is provided suitable for use in visual display devices, such as Cathode Ray Tubes (CRTs) and Plasma Display Panels (PDPs) comprising a set of polarizers comprising reflective polarizer means and absorbing polarizer means, and optionally a quarter wave retardation means, which enhances the luminance-contrast performance of said visual display devices, wherein said reflective polarizer means is comprised of birefringent inorganic thin-film material, e.g. silica. This inorganic polarizer material is preferably arranged at the inner side of the display and resists the manufacturing and operating conditions in a display device. Light emitted by the phosphor dots becomes polarized with an efficiency between 50 and 100%. This polarized light is fully transmitted by the dichroic polarizer whereas incident daylight is absorbed for more than 50%. Also claimed are visual display devices comprising said assembly, and methods of manufacturing said assembly and said visual display devices.

### TECHNICAL FIELD

This invention generally relates to visual display devices, and is more particularly concerned with filters for enhancing the image contrast of such devices, and methods of preparing them.

### BACKGROUND OF THE INVENTION AND RELATED ART

The daylight contrast of a cathode ray tube (CRT) is relatively poor because of reflection of light at the phosphors. The daylight contrast has been largely improved by a number of measures such as pigmenting of the screen glass, adding colour filters in between the screen glass and the phosphor dots and adding pigments to the phosphor dots themselves. Most effective is the pigmentation of the screen glass. But besides improving the daylight contrast these measures also reduce the light yield and brightness of the CRT.

Instead of or in addition to pigmenting the screen glass, adhering a polarizer film at the front screen of the CRT can also enforce absorption of daylight. Commercially available are polarizer film/quarter wave film combinations that also reduce specular reflections at the glass and partly at the phosphors in a very effective way. The principle is based on the fact that the incoming light is already absorbed for 50% or more. Then the beam has become linearly polarized. Next the beam is converted into circularly polarized light in the quarter wave film. Upon specular reflection (which by the way generally is a relatively small part of the beam) the handedness of circular polarization is inverted such that the reflected beam on its path through the quarter wave and the polar again is completely absorbed. Although this system works very effective for the incoming beam, still also more than 50% of the emitted phosphor light is absorbed.

Plasma display panels (PDPs) largely suffer from similar problems.

I. J. Hodgkinson et al., In Complex Mediums, A, Lakhtakia, W. S. Weiglhofer, R. F. Messier, Ed., Proceedings of SPIE Vol. 4097, 266-279 (2000), disclose a serial bideposition (SBD) technique to deposit thin film wave plates and chiral reflectors of SBD silicon for use with linearly and circularly polarized light at visible and near infrared wavelengths.

U.S. Pat. No. 4,896,218 discloses a contrast enhancement filter for use on display devices which utilizes a multiple bandpass optical interference filter with the passbands matched to predetermined desired frequencies of the display device, a circular polarizer disposed outwardly from said interference filter, and an anti-reflective coating deposited thereon.

U.S. Pat. No. 4,747,674 discloses a contrast enhancement filter for the reduction of specular glare from the surface of CRTs, computer display screens, and the like, having antistatic and antireflection properties, which comprises a plastic support sheet carrying on one side thereof a layer of indium tin oxide, and superposed thereon an antireflection layer. A light-polarizing element is affixed to the opposite side thereof.

EP-B-0 085 617 discloses a contrast enhancing optical filter device which comprises a first and a second optical filter means being both located in front of the face of a cathode ray tube. The first optical filter means is made up of a circularly polarizing filter which is coated with an anti-reflective coating, such as magnesium fluoride, silicon monoxide or other specially developed proprietary materials. The second optical filter means is made up of a glass plate and has a thin film passband film deposited thereon.

U.S. Pat. No. 5,101,136 discloses a cathodoluminescent screen for high-luminance cathode-ray tubes which includes a glass substrate carrying a luminescent screen consisting of luminophor grains. An intermediate screen is inserted between the luminescent screen and the substrate. The refraction index of the intermediate screen is greater than the refraction index of the substrate, resulting in the reflection of a considerable part of the light penetrating the intermediate layer into the direction of the luminescent layer, so that this light can then be rediffused to the substrate.

There is still a need for improvement in contrast enhancement filters for visual displays in environments having bright ambient light which will result in increased contrast enhancement.

### SUMMARY OF THE INVENTION

It is an object of the present invention to provide an assembly suitable for use in visual display devices comprising a set of polarizers comprising reflective polarizer means and absorbing polarizer means which enhances the contrast of said visual display devices, and usually a quarter wave film, wherein said reflective polarizer means is comprised of birefringent inorganic thin-film material.

In a preferred embodiment of the invention said birefringent inorganic material consists essentially of silica.

It is another object of the invention to provide a simple way to manufacture said assembly and said visual display devices with enhanced contrast comprising said reflective polarizer means of birefringent inorganic material and said absorbing polarizer means, and usually said quarter wave film by a process which comprises the step of evaporating said birefringent inorganic material on a rotating substrate.

It is a feature of the present invention to improve the contrast of a CRT which comprises a display screen, usually made of glass, and a layer comprised of phosphor dots, by using an assembly of polarizers comprising a reflective polarizing layer of birefringent inorganic thin-film material and an absorbing polarizing layer, and usually a quarter wave film, wherein said reflective polarizing layer is arranged inside the tube in-between said phosphor layer and said display screen.

Preferably, said reflective polarizing layer is a circular reflective polarizing layer, which will also be denoted hereinafter as a chiral reflector, and which is preferably evaporated on the substrate by a rotation method known in the art.

It is another feature of the present invention to improve the contrast of a plasma display panel (PDP) which comprises a display screen, usually made of glass, by using an assembly of polarizers comprising a reflective polarizing layer of birefringent inorganic thin-film material and an absorbing polarizing layer, and usually a quarter wave film, wherein said reflective polarizing layer is arranged at the inner side of the panel, preferably adjacent to the display screen.

It is still another object of the invention to provide a method of manufacturing an assembly of polarizers comprising a reflective polarizing layer of birefringent inorganic thin-film material and an absorbing polarizing layer, and usually a quarter wave film, for use in a visual display device with enhanced contrast performance, which comprises the step of evaporating said reflective polarizing layer on a substrate by electron-beam evaporation of an inorganic source in vacuo while the substrate is rotated under an angle with the line that connects the source with the substrate.

In a preferred embodiment the rotation speed is gradually changed to form a helical structure of the birefringent inorganic material of which the pitch of the helix is changed over the thickness of the film.

The present invention provides a reflective polarizing filter means that is designed to fulfil the above-mentioned needs, which contains the features described above and produces the above stated advantages.

These and other aspects of the present invention will be described below in some more detail.

### BRIEF DESCRIPTION OF THE DRAWINGS

FIG. 1 is a diagrammatic, cross-sectional view of a preferred embodiment of the present invention showing a cathode ray tube (CRT) comprising as the main components a glass screen, an assembly of an inorganic circular reflective polarizer, a quarter wave film, and a linear dichroic polarizer according to the present invention, and a layer of phosphor dots.

FIG. 2 is a diagrammatic, cross-sectional view of a preferred embodiment of the present invention showing a plasma display panel (PDP) comprising a glass screen, an assembly of an inorganic circular reflective polarizer, a quarter wave film, and a linear dichroic polarizer according to the present invention, and several other layers which will be more detailed below.

FIG. 3 is a diagrammatic outline of the deposition of a chiral film on a CRT screen. The rotation CRT screen now refers to the pristine front glass of the CRT before application of the phosphors or assembling of tube.

FIG. 4 represents a diagrammatic, cross-sectional view of an alternative embodiment of the invention showing a different structure, forming a contrast enhancement filter of the invention.

### DETAILED DESCRIPTION OF THE INVENTION

The present invention is partly based on the light recycling principle that has been developed for LCDs. A reflective cholesteric colour filter polarizes light by reflection rather than by absorption. The reflected light of the for transmission wrong polarization becomes depolarized at scattering media. Upon re-direction the depolarized light again into the viewers direction it has partly adopted the right polarization and thus partly will be transmitted in the second pass. The “wrong” light is reflected again but gets another chance on its third or fourth path, etc. The result is polarized light which can be produced in a substantially higher yield than 50% which is the theoretical limit for absorbing polarizers.

This principle basically can be used both for CRTs and PDPs. However, the reflective polarizers of the prior art are organic in nature and must therefore be placed at the outer glass surface of the screen. Upon reflection of the emitted light, because of the glass thickness and the corresponding large distance between image-generating dots and the reflector, this causes all sorts of misalignment and parallax problems. Placing the organic polarizer inside the tube causes degradation problems during the manufacturing of the tube (heat) and during operation (electrons).

Recently, new inorganic polarizers have been developed based on birefringent inorganic materials, such as silica, that are evaporated on a rotating substrate; see I. J. Hodgkinson et al., supra. Also, highly durable inorganic thin-film circular reflective UV polarizers of silica are disclosed by Reveo, Inc.; see, e.g., http://www.reveo.com/technologieslpolarizing/uv.htm, which technology is based on the same principle.

In accordance with the present invention it was surprisingly found that the properties of these high-durability circular polarizers could be successfully utilized in CRTs and PDPs in combination with dichroic polarizers, and usually a quarter wave film, by bringing said chiral polarizer inside the CRT or PDP close to the pixel elements. One now can benefit from the improved light output of light with a single circular polarization. At the other side of the glass tube a quarter wave film (in case of circular polarized light) and a dichroic absorbing linear polarizer are placed, respectively. The angle between the optical axis of the quarter wave and the polarizer is chosen such that substantially all emitted light is transmitted, whereas the incident light is absorbed to a large extent. These new inorganic polarizers are preferably made of silica, but any other substance having similar temperature-resistant and high-durability properties may be applied as well. Other suitable substances are, for example titanium dioxide, magnesium fluoride or zinc sulfide.

A typical way to manufacture the dichroic polarizer front is to start with a thin glass substrate that is coated with a water based lyotropic polarizer film (e.g. from Optiva Inc.). This polarizer film is coated with a thin orientation film, e.g. a coumarin based photo-alignment film that is aligned by polarized UV with its plane of polarization at 45° with the polarization axis of the first film. A liquid crystalline acrylate film is coated next on this stack to form the quarter wave retardation layer (which is only needed when circular polarized light is used, as will be evident to a person skilled in the art). This composite is then adhered to the front screen of the CRT with the glass substrate facing to the viewer, thus providing a scratch resistant surface that eventually is coated with a conventional anti-reflection coating.

In a preferred embodiment of the invention the chiral reflector is evaporated on the inside of the CRT screen by oblique evaporation, essentially following the method described by Hodgkinson, supra (see FIG. 3). When the angular position ξ of the CRT screen substrate is chosen to be 0°, 184.5°, 9°, 193.5°, 18° , . . . , a double helix normal columnar chiral structure is formed. This helix gives reflection of circularly polarized light of one handedness, corresponding to the original rotation direction, and transmission of circularly polarized light with opposite handedness. For instance, a SiO₂ film (average refractive index is 2.1 and the birefringence is 0.116) with a rotation number of 15. The pitch of the helix is 173 nm. The film is applied on a glass substrate (refractive index is 1.52) and measured against air, which gives a reflection band with its peak maximum at 610 nm and a band width of 40 nm. The pitch of the chiral helix is adjusted by the rotation speed of the CRT screen. Broadening of the reflection band, expanding over the visible wavelength region, can be obtained by a gradual increase of the pitch from a value of about 50 nm to about 250 nm, typically from about 100 nm to about 200 nm.

After evaporation of the circularly polarizer the phosphor dots are applied directly on top of the chiral film by known lithographic technologies. If desired, also black matrix layer can be applied, either in between the chiral polarizer and the CRT glass (preferred) or between the chiral polarizer and the phosphor dots to improve further on the luminance contrast performance.

Prior to applying the organic dichroic polarizer and quarter wave films the CRT front screen is mounted to the electron gun tube and evacuated.

A preferred way to manufacture the dichroic polarizer front for a CRT with a flat front screen is to start with a thin glass substrate that is coated at one side with an antireflective (AR) coating of for instance MgF₂ with a quarter wave thickness. At the side opposite to the AR layer this glass plate is coated with a dichroic polarizer film. This film is suitably applied by blade coating using a water based lyotropic polymer dye mixture. This film is commercially available from Optiva Inc. The high performance polarizer coating results from shear force applied to the liquid as it is applied. This shear force acts to create a preferred orientation, and “comb” the supramolecular strands created by self-assembly of the LCP material. After shear force establishes a partial orientation, the liquid crystal property of the strands act to increase alignment. The deposition method should allow producing the uniform polarizing coating of 7 to 15 micron thick (wet layer). Preferred deposition methods are doctor or slot die. After evaporation of water, a thin crystalline polarizing layer remains of 0.5-1 μm thick (dry layer). The absorption axis can be chosen differently and has some implication on the absorption characteristics of ambient light. An absorption axis which is vertical has an improved ambient light contrast when light strikes the CRT tube in a substantial horizontal way, e.g. when light is coming from a window in a living room situation. When the optical axis is chosen to be horizontal it provides a somewhat higher absorbing efficiency for ambient light coming from the top of the bottom such as from a lamp attached to the ceiling of the living room. For light coming along the normal of the CRT screen the polarizer orientation has no importance.

In turn the dichroic polar layer is coated with an orientation layer for alignment of the quarter wave film. The alignment layer may be a thin, e.g. 30 nm polyimide film as is known from LCD manufacturing, and which is supplied e.g. by Nissan and JSR. It is very important that the alignment film does not deteriorate the polarizer film. Its solvent must therefore be a non-solvent for the polarizer film and relatively ‘mild’ to prevent phenomena such as stress cracking of the polarizer film. In a preferred embodiment use is made of a Coumarin photoalignment layer which is suitably applied by blade coating, spin coating or printing using e.g. cyclohexanone as a solvent. The alignment film is supplied by Vantico Corp. and is described, for example, by M. Schadt, H. Seiberle and A. Schuster, Nature, 381, 212 (1996). The alignment function is obtained during a photo-crosslinking reaction induced by exposure with polarized UV light and presently widely studied for LCD applications. The orientation axis that is selected by the polarization direction of the UV light depends on the type of circular polarizer that is applied inside the CRT screen, i.e. right- or left-handed. It must be chosen such that the circularly polarized light transmitted by the circular polarizer will be converted into linearly polarized light with a sense that the dichroic polarizer transmits it.

After application of the polarizer film a quarter wave film is usually applied, for example by spincoating of an about 12 wt. % solution of a 1:1 mixture of 2-methyl-1,4-phenylene bis {4-[6-(acryloyloxy)propyloxy]benzoate } and 2-methyl-1,4-phenylene bis {4-[6-(acryloyloxy)hexyloxy]benzoate } (also referred to as C3M and C6M, respectively), modified with an initiator, preferably an about 2 wt. % photoinitiator (e.g. Irgacure 651—CIBA Specialty Chemicals) in a suitable solvent, such as methylethyl ketone, drying at 80° C. and subsequent UV curing at an appropriate temperature, suitably at about 40° C. in nitrogen.

The monomers align in the direction that the alignment layer imposes. The birefringence of the aligned polymer network that is formed typically is 0.16. The preferred thickness is 0.86 μm.

The glass plate with the adhered coatings is optically connected to the CRT screen by means of an optical adhesive known in the art. The quarter wave film faces to the screen whereas the AR layer faces to the viewer. A preferred optical adhesive is based on a mixture of 66 wt. % ethylhexyl acrylate, 22 wt. % phenoxyethyl acrylate, 10 wt. % ethoxylated bisphenol-A diacrylate and 2 wt % Irgacure 184 as photoinitiator. The mixture is applied in between the coated glass plate and the CRT screen, and UV cured.

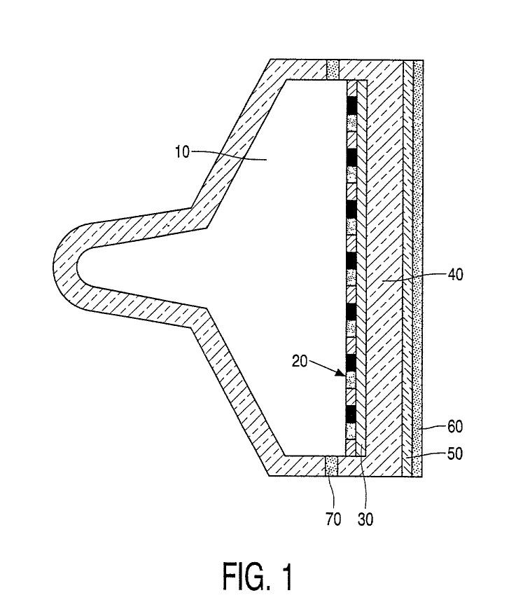

Reference is now made to FIG. 1 which represents a typical and preferred embodiment of the invention, showing a common CRT (10), comprising a glass screen (40), a layer (20) consisting of phosphor dots (R,Y,B) inside the tube, an inorganic reflective circular polarizer layer (30) according to the present invention between the glass screen and the phosphor dots, and on the opposite side of the screen a quarter wave film (50), and a dichroic linear polarizer (60). The glass screen (40) is sealed onto the CRT with a suitable adhesive (70). Methods for the production of the respective layers are as described above. The CRT is further provided with electrodes (not shown) and other commonly known elements, such as shadow masks and black matrix coating inside the tube and deflection coils outside the neck of the tube. The quarter wave film (50) is suitably made of a 1:1 mixture of C3M and C6M, as indicated above, in a suitable solvent such as methyl ethyl ketone, to which a suitable photoinitiator is added, for example Irgacure 651, for UV curing of the layer. A suitable and preferred method of applying the quarter wave layer (50) on the substrate is by spincoating. Concentrations and other conditions for applying the quarter wave layer (50) are known in the art or can be easily determined by a skilled person without any inventive effort. Other suitable materials for forming a quarter wave film include uniaxially stretched polycarbonate film that must be laminated to either the polarizer film (60) or to the glass (40) of the CRT screen.

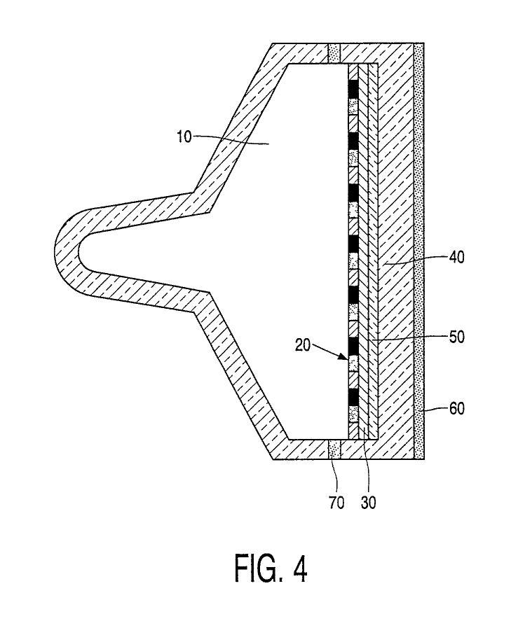

FIG. 4 shows an alternative embodiment of a CRT with a contrast enhancement filter of the invention. The reference numbers with a dash (′) correspond with the reference numbers of FIG. 1. According to this embodiment, inorganic birefringent materials are used for the quarter wave layer (50, 50′), such as silica. This has the advantage that these materials can be applied inside the television tube in between the circular polarizer and the glass (40′) of the front screen. The tube that is formed in this way directly emits linear polarized light.

The structure and function of the linear dichroic polarizer (60, 60′) is also commonly known in the art, as are the methods of applying such polarizers onto a substrate. In the embodiment shown in FIG. 1, the quarter wave film (50) is directly applied on the external side of the tube, and the linear dichroic polarizer film (60) is applied onto the quarter wave film. Evidently, these two films are made such that the materials are compatible with each other. The linear dichroic polarizer is suitably made e.g. of a water based lyotropic polymer dye mixture, as indicated above. Other suitable materials are known in the art.

Instead of using coatable polarizer films, also polarizer films which are commercially available with a pressure sensitive adhesive, and which can be laminated either directly on the screen glass or on top of a laminated quarter wave film can be suitably used.

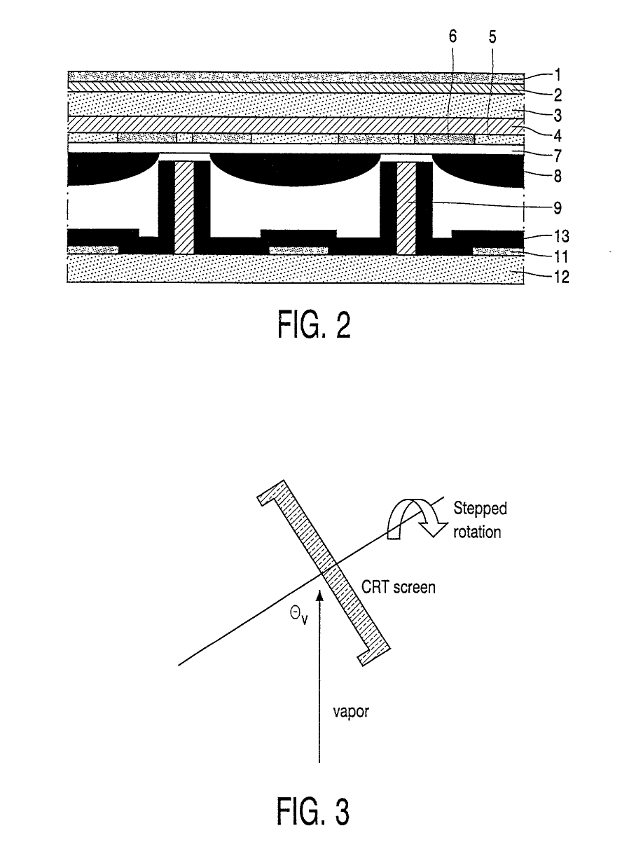

Although the present invention is illustrated by the use of a reflective polarizing layer inside a CRT, it is to be understood that the same principle of luminance-contrast performance (LCP) enhancement can be applied to, and is very valuable for plasma display panels (PDP) as well. The circular polarizer resists UV and is compatible with the PDP manufacturing processes. Therefore the polarizer can also be brought inside the PDP panel. This is illustrated in FIG. 2, in which the reference numbers refer to the following layers: 1. Linear polarizer film (dichroic type); 2. Quarter wave film; 3, Glass; 4. Inorganic reflective polarizer; 5. Dielectric layer; 6. Transparent electrodes; 7. MgO barrier layer; 8. Visualization of the plasma; 9. Barrier rib; 13. Phosphor (R,Y,B); 11. Electrode; 12. Glass plate. For a description of a state-of-the-art PDP, reference is made to H. Hirakawa, et al., Proceedings of the SID International Symposium, Anaheim, May 17-22—California, 279, (1998). As stated above, the primary object of the present invention is the use of new birefringent inorganic reflective materials which can be brought inside a CRT tube close to the pixel elements. However, it will be understood by people of ordinary skill in the art that such these new birefringent inorganic reflective materials may also be applied, if desired, at the outer side of the CRT, preferably using the same rotational evaporation technique, in applications such as the CRT and PDP although this embodiment is not a preferred one.

The new structures according to the present invention are useful in any applications where it is desired to pass predetermined wavelengths of light in one direction through the structure while substantially blocking light from passing in an opposite direction, in particular in visual displays in environments with high contrast, e.g. displays which are directly exposed to (bright) daylight.

In a further embodiment of the present invention, a method is provided for preparing an assembly suitable for use in visual display devices, such as CRTs or PDPs, comprising a set of polarizers comprising reflective polarizer means and absorbing polarizer means which enhances the contrast of said visual display devices, and optionally a quarter wave film, wherein said reflective polarizer means is comprised of birefringent inorganic thin-film material, typically silica, which comprises the step of applying said birefringent inorganic thin-film material by oblique evaporation of silicon dioxide on a rotating substrate. The substrate is the inner surface of the CRT front screen. The screen is therefore placed in a vacuum chamber provided with the SiO₂ source. The surface of the screen is placed under an angle with the line that connects the source with the substrate. The SiO₂ films are deposited onto the screen surface by electron-beam evaporation of the SiO₂ source. While the SiO₂ film is grown, the CRT screen is rotated. In a preferred embodiment the speed of rotation is changed while the SiO₂ film is deposited. As a result a helical structure is formed of which the pitch of the helix is changed over the thickness of the film. The polarizer function thus generated is widebanded and expands over the whole visible spectrum, whereas the single pitch circular polarizer films may have a more narrow reflection band depending on the optical properties of the film.

In yet another embodiment of the present invention, a visual display device is provided, such as an CRT of PDP, with enhanced contrast performance, comprising an assembly of polarizers comprising reflective polarizer means and absorbing polarizer means, and optionally a quarter wave film, wherein said reflective polarizer means is comprised of birefringent inorganic thin-film material, e.g. silica, which is deposited onto the screen surface using the deposition method described above, which is essentially similar to the method described by Hodgkinson et al., supra.

The present disclosure is to be considered as in all respects illustrative and not restrictive, the scope of the invention being indicated by the appended claims, and all changes which come within the meaning and range of equivalency are intended to be embraced therein.

1. An assembly suitable for use in visual display devices comprising a set of polarizers comprising reflective polarizer means and absorbing polarizer means, and optionally a quarter wave retardation means, which enhances the contrast of said visual display devices, wherein said reflective polarizer means is comprised of birefringent inorganic thin-film material.

2. An assembly according to claim 1, wherein said birefringent inorganic thin-film material consists essentially of material selected from the group of silica, titanium dioxide, magnesium fluoride, and zinc sulfide.

3. An assembly according to claim 1 or claim 2, wherein said reflective polarizer means is a circular reflective polarizing layer.

4. An assembly according to any one of claims 1 to 3, wherein said reflective polarizer means is a circular reflective polarizing layer based on a birefringent material of which the optical axis rotates in a direction parallel to the normal of the film.

5. An assembly according to any one of claims 1 to 4, wherein said reflective polarizer means is a circular reflective polarizing layer based on a birefringent material of which the optical axis rotates in a direction parallel to the normal of the film where the pitch of the rotation is changed.

6. An assembly according to any one of claims 1 to 5, wherein said reflective polarizer means is a circular reflective polarizing layer based on evaporated birefringent inorganic material, such as silica, of which the optical axis rotates in a direction parallel to the normal of the film where the pitch of the rotation is changed gradually from a value of about 50 nm to about 250 nm.

7. An assembly according to any one of claim 1 to 6, wherein said reflective polarizer means is a circular rejective polarizing layer based on a birefringent material of which the optical axis rotates in a direction parallel to the normal of the film, where the pitch of the rotation is changed by altering the speed of rotation of the substrate during the evaporation process of the inorganic film.

8. An assembly according to claim 1 or claim 2, wherein said reflective polarizer means is a linear reflective polarizing layer.

9. A visual display device which comprises an assembly as claimed in any one of claims 1 to 8.

10. The visual display device according to claim 9, wherein said device is a cathode ray tube (CRT) or a plasma display panel (PDP).

11. A CRT visual display device according to claim 9, which comprises a display screen and a layer comprised of phosphor dots, and a set of polarizers comprising a reflective polarizing layer, an absorbing polarizing layer, and optionally a quarter wave layer, wherein said reflective polarizing layer is arranged inside the tube in-between said layer comprised of phosphor dots and said display screen.

12. A PDP visual display device according to claim 9, which comprises a display screen and an assembly of polarizers comprising a reflective polarizing layer of birefringent inorganic thin-film material and an absorbing polarizing layer, and usually a quarter wave film, wherein said reflective polarizing layer is arranged at the inner side of the panel, preferably adjacent to the display screen.

13. A method of manufacturing an assembly as defined in any one of claims 1 to 8, for use in a visual display device with enhanced contrast performance, which comprises the step of evaporating said reflective polarizing layer on a substrate by electron-beam evaporation of an inorganic source in vacuo while the substrate is rotated under an angle with the line that connects the source with the substrate.

14. A visual display device with enhanced contrast performance comprising an assembly of polarizers comprising reflective polarizer means and absorbing polarizer means, and optionally a quarter wave film, wherein said reflective polarizer means is comprised of birefringent inorganic thin-film material, characterized in that said assembly is made using the method of claim 13.
